(19) United States
(12) Patent Application Publication
(10) Pub. No.: US 2011/0244216 A1
(43) Pub. Date: Oct. 6, 2011

(54) THERMAL BARRIER COATING SYSTEM AND METHOD FOR THE PRODUCTION THEREOF

(76) Inventors: Alexandra Meyer, Koeln (DE); Holger Kassner, Pullach (DE); Robert Vassen, Herzogenrath (DE); Detlev Stoever, Niederzier (DE); Jose-Luis Marques-Lopez, Muenchen (DE)

(21) Appl. No.: 12/735,609

(22) PCT Filed: Jan. 29, 2009
(86) PCT No.: PCT/DE2009/000120

§ 371 Date: Apr. 4, 2011

(30) Foreign Application Priority Data
Feb. 6, 2008 (DE) 10 2008 007 870.0

(51) Int. Cl. B32B 3/26; C23C 4/00; C23C 4/10

(52) U.S. Cl. 428/316.6; 427/446; 427/448; 427/453

(57) ABSTRACT

Disclosed is a method for producing a coating system on a component, wherein at least one coating is deposited on the component by way of atmospheric plasma spraying (APS) and at least one further coating is deposited by way of suspension plasma spraying (SPS). The coatings are particularly advantageously deposited in the sequence of APS+SPS or APS+SPS+APS or APS+SPS+erosion coating. These sequences of coatings applied in this way usually have an effect providing a first porous coating and a second porous coating disposed thereon, wherein the porosity of the second coating is greater than that of the first coating, and wherein the reflectivity is greater than that of the first coating. The increased reflectivity of the coating, particularly in the visible (VIS) and the near infrared (NIR) wavelength ranges, advantageously causes a lower thermal load for the substrate material because a smaller proportion of thermal radiation penetrates the ceramic thermal barrier coating, resulting in lower heating of the substrate (component).

The invention relates to a coating system, and particularly to a coating system for use as a thermal barrier coating, and to a method for producing such a coating system.

### STATE OF THE ART

Ceramic thermal barrier coatings are used effectively in gas turbines, where they operate without difficulty for more than 25,000 hours under the typical gas turbine usage conditions, notably due to the structural stability and the reliability of the thermal barrier coating. Premature failure of the thermal barrier coating would result in overheating of the base material (the component to be protected), and potentially in damage to the turbine. Costs related to downtime and repairs that this causes can be considerable and, in some circumstances, can eliminate the technological benefit of the thermal barrier coating.

In order to increase the efficiency of gas turbines, it is necessary to raise the turbine inlet temperature from approximately 1230° C. to approximately 1350° C. This goal can be achieved by employing ceramic thermal barrier coatings, in addition to the use of improved base materials and effective cooling methods. Because of the thermally insulating effect of the ceramic thermal barrier coating, the permitted surface temperature can be raised by several 100 K, depending on the thickness of the thermal barrier coating, while maintaining the same cooling conditions. The higher thermal load, however, frequently shortens the service life of the thermal coating system.

The thermal insulation effect of the thermal barrier coatings used is generally based on the formation of a temperature gradient over the thermal barrier coating, which conducts heat poorly. Characteristic variables are the heat flow over the thermal barrier coating and the temperature of the component protected by the thermal barrier coating.

In practice, better efficiency and component reliability are sought through increasing the thickness of the thermal barrier coating and by reducing the thermal conductivity of the materials in the thermal barrier coating. However, since the maximum coating thickness for the thermal barrier coating is limited, because the risk of premature failure of the thermal barrier coating increases with greater thicknesses, due to flaking and process technology considerations, this solution is practicable only under certain conditions.

A considerable reduction in the thermal conductivity of heat barrier coatings, however, can be reliably achieved by using ceramic materials that have an appropriately low intrinsic thermal conductivity. Thermal barrier coatings in the form of duplex structures are standardly used. The first layer comprises a metallic coating, which is intended to protect the substrate (component) beneath from corrosion and oxidation. This coating also generally serves as an adhesion promoter coating for the actual thermal barrier coating, which is the second coating of the duplex structure. This second coating, which performs the actual thermal insulation function, is frequently a ceramic coating. This coating typically comprises yttrium-stabilized zirconia (YSZ) or other oxide ceramics. Furthermore, newer thermal barrier coating systems sometimes comprise multi-layer coating systems made of different ceramics.

With the goal of producing thin functional coatings, various variant methods have been developed in recent years in the field of plasma spraying. They differ from each other primarily in terms of the ambient conditions, such as being performed under an atmosphere or under vacuum. Some of these were developed for specific applications or special spray materials. In addition to the established methods for producing thermal barrier coatings, such as PVD (Physical Vapor Deposition), and various thermal spray processes such as APS (Atmospheric Plasma Spray), VPS (Vacuum Plasma Spray) and HVOF (High-Velocity Oxygen Fuel, High Valued Oxygen Flaming, High Velocity Oxygen Flaming) processes, it is also possible to employ CVD (Chemical Vapor Deposition) and CVI (Chemical Vapor Infiltration) for the production process. Coatings produced by way of atmospheric plasma spraying (APS) usually require free-flowing powders.

One of the more recent developments is suspension plasma spraying (SPS), in which a suspension of small particles is radially introduced into the plasma arc. It has been found that, when using particles which are 1 to 3 orders of magnitude smaller than those used in conventional APS, significantly thinner coatings (<50 μm) can be achieved by way of SPS. The suspension is introduced into the light arc by way of an atomizer nozzle using a pressurized gas, such as compressed air, nitrogen or argon. It is also possible, however, to introduce the suspension into the free plasma jet directly by way of a suitable injector. The suspension is atomized into very fine droplets. As a result of the plasma discharge, the suspension solution is evaporated almost instantly, and the small solid particles are massed together into partially or completely melted droplets and accelerated, so as to impact the substrate and form a coating there. Suspension plasma spraying can be employed both for coatings made of ceramic material and those made of metallic materials, with very fine, dense spherical particles being used in each case.

In conclusion it can be said that the maximum achievable insulation effect for thermal barrier coatings is determined by the thermal conductivity of the material of the thermal barrier coating and by the coating thickness. To this end, the insulation effect of thermal barrier coatings shall be understood as the drop in temperature over the thermal barrier coating. The coating thickness is constrained by the mechanical properties that must be met, and cannot be increased arbitrarily. These two parameters constitute a basic obstacle for all thermal barrier coating systems.

Problem and Solution

It is the object of the invention to provide a thermal barrier coating system which, as compared with that known from the prior art, has a comparable or even improved mechanical stability and service life, even at high thermal loads.

It is a further object to provide a method for producing such a thermal barrier coating system.

The objects of the invention are achieved by a method for producing a thermal barrier coating system according to the main claim and by a thermal barrier coating system according to the additional independent claim. Advantageous embodiments of the method and of the system will be apparent from the respective dependent claims.

Subject Matter of the Invention Within the context of the invention, it was found that process-related constraints in the use of the APS method for producing a thermal barrier coating with respect to the powder to be used in terms of the particle size of the oxide ceramics also lead to constraints in terms of the microstructure and the resulting physical properties, such as the thermal conductivity or optical properties (transmission, absorption, reflection). It was found that the YSZ material used as standard, as well as many other oxide ceramics, exhibit high transparency in the near infrared wavelength range. The disadvantage is that this creates a high thermal load on the substrate material because the thermal radiation penetrates the ceramic thermal barrier coating, thereby heating the substrate (component). In addition, there are upper limits to the adjustable porosity of a coating produced by APS, and thus of heat conduction can only be reduced to a certain extent.

The basic principle of the invention is the combination of the APS and SPS methods in the production of a thermal barrier coating system in order to create coatings having different microstructures and properties. In this way, thermal barrier coatings having defined mechanical and physical properties, in particular with respect to the thermal conductivity, transparency, absorption or reflection, can be created, which cannot be attained by the single-layer system that was common up to now. The thermal barrier coating system according to the invention therefore comprises at least one coating which was produced by way of SPS and at least one further coating produced by way of APS.

The suspension plasma spray (SPS) process allows for direct processing of nanoparticles. Because of the process, and because of the significantly reduced particle size, it is possible to produce coatings which have different microstructures and improved physical and optical properties. The SPS process thus allows a coating to be produced which has a significantly higher porosity and microcrack density than APS. This increases the dispersion of the thermal radiation, whereby optical properties, such as reflectivity, can be improved, even in the near infrared wavelength range. In addition, the increased porosity results in reduced thermal conductivity. Both factors together considerably reduce the thermal load on the substrate material by thermal radiation and heat conductance. However, highly porous, thick SPS coatings have a lower mechanical stability than comparably thick conventional APS coatings. This can lead to limited application possibilities for high-load components, a shortened service life, and a reduced erosion stability of the thermal barrier coating system. In addition, the costs for SPS coatings are considerably higher than for comparable APS coatings due to lower process efficiencies and higher material costs.

The respective disadvantages of the individual systems can be compensated for by using APS and SPS coatings. The APS coating, for example, can be used in particular as a coating exhibiting mechanical and erosive stability, and the SPS coating can be used in particular to improve the reflectivity and reduce the thermal conductivity. Combining both processes in a multi-layer system allows the advantages of the individual coatings to be ideally merged, allowing applications which are not possible with the individual coating systems.

The particularly advantageous effects of the thermal barrier coating according to the invention are the increase in the reflectivity and the reduction in the thermal conductivity of the ceramic topcoat.

Materials that are in principle suited for this thermal barrier coating system include oxide ceramics, such as variants of stabilized ZrO₂ (for example, partially stabilized YSZ, fully stabilized YSZ), aluminum oxide, aluminates, (such as garnets), pyrochlores and perovskites.

The transition between the individual coating systems can, for example, take place either separately or gradually.

The advantageous effects of the design of the coating system according to the invention are not necessarily dependent on the individual coating thicknesses.

Double layers comprising an SPS coating in the upper region usually exhibit a higher reflectivity than a pure APS coating having the same coating thickness.

The coating thicknesses, however, influence the reflectivity, which is to say, the thicker the coating, the greater the volume which can reflect the light. However, it can be assumed that saturation is reached starting at a certain coating thickness.

List of the abbreviations used in this application:

PVD physical vapor deposition

APS atmospheric plasma spraying

VPS vacuum plasma spraying

HVOF high-velocity oxygen fuel, high-valued oxygen flaming, high-velocity oxygen flaming

CVD chemical vapor deposition

CVI chemical vapor infiltration

YSZ fully or partially stabilized zirconia

ZrO₂ zirconium dioxide

### SPECIFIC DESCRIPTION

The invention will be explained in more detail hereinafter based on several exemplary embodiments and figures. Shown are:

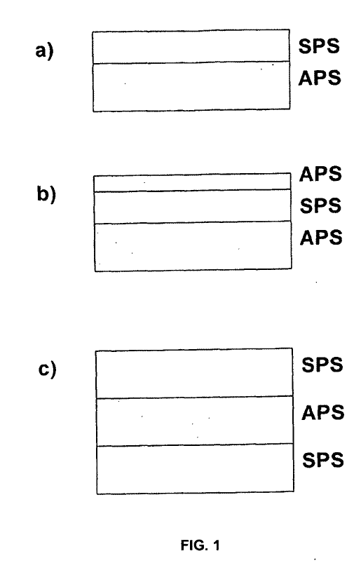

FIG. 1: schematic thermal barrier coating systems

a) Double-layer system having high reflectivity and porosity at the surface

b) Double-layer system having erosion coating

c) Triple-layer system having high reflectivity and porosity.

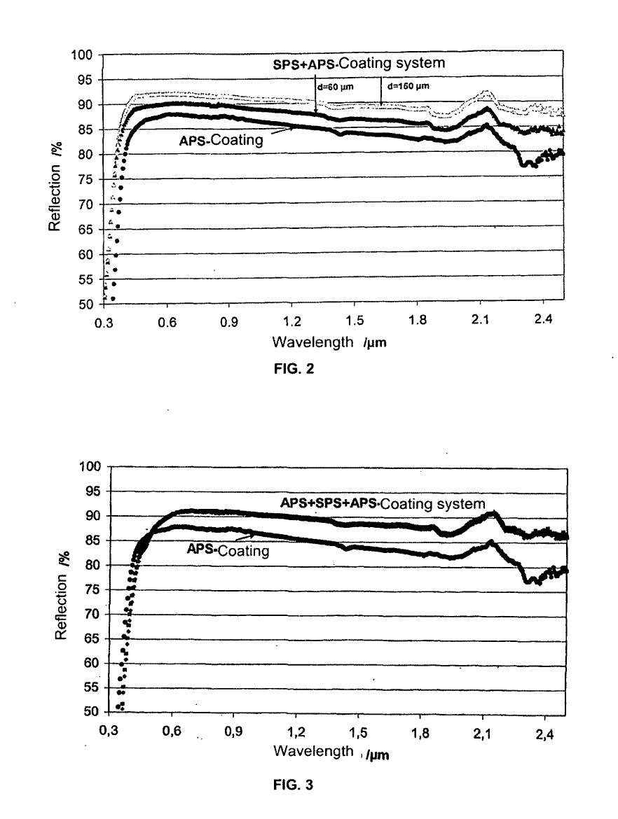

FIG. 2: Dependence of the reflection in % over the wavelength range of 0.3 to 2.5 μm for a thermal barrier coating according to the invention and a conventional thermal barrier coating (APS only).

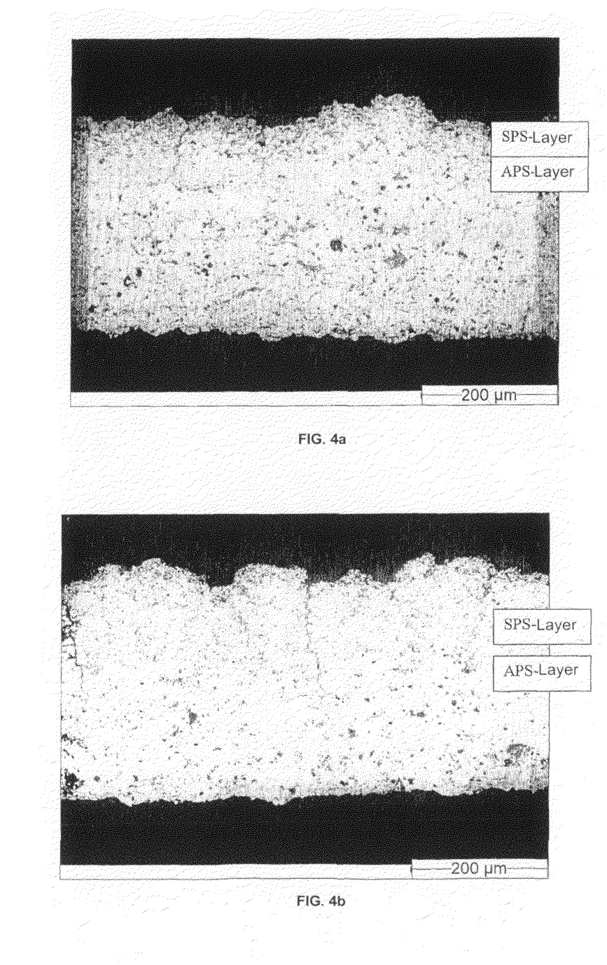

FIG. 3: Dependence of the reflection in % over the wavelength range of 0.3 to 2.5 μm for a thermal barrier coating according to the invention comprising an erosion protection coating and a conventional thermal barrier coating (APS only).

The object of the invention, which is that of increasing the service life of thermal barrier coating systems by reducing the thermal load due to thermal radiation and the conductance of heat in metallic substrates, is achieved according to the invention by increasing the reflectivity and reducing the thermal conductivity of the ceramic topcoat.

FIG. 1 schematically illustrates the composition of thermal barrier coating systems according to the invention, comprising a combination of at least one coating produced by way of an APS process (APS coating) and at least one further layer produced by way of an SPS process (SPS coating). The composition is shown from the bottom up, toward the surface, as it would be obtained on a component (not shown).

Exemplary Embodiment for Composition a)

The suspension used for the SPS method comprises 5YSZ powder in ethanol, the average particle size of the 5YSZ powder in the suspension being d₅₀=40 nm. The solid contents of the powder in the suspension were 10% by weight (Example 1) and 20% by weight (Example 2). The suspension pressure was 2 bar, and this was operated at an air pressure of 0.5 bar.

In Example 1, the coating thickness of the SPS coating was varied between 60 and 150 μm. The thermal conductivity of this coating was only 0.58 W/mK, and the coating had a porosity of approximately 29%.

During the APS process, a spray-dried YSZ powder from Sulzer Metco (Wohlen, Switzerland) having a mean grain size of d₅₀=44 μm was sprayed. The powder is characterized by spherical and predominantly tall particles. The spray distance was 150 mm. The output of the burner (Triplex II) was 57 kW. It was also used in the SPS process. The APS coating, in contrast, has a porosity of only 9% and a thermal conductivity of approximately 1.1 W/mK.

The overall coating thickness of the aforementioned double layers was approximately 330 to 360 μm, while that of the APS coating produced for comparison purposes was approximately 380 mm.

Exemplary Embodiment for Composition b)

The double-layer APS+SPS coating was produced as in the case of Composition a). Similar to Composition a), the SPS coating was adjusted to a coating thickness of approximately 170 μm. The thermal conductivity of this coating was 0.76 W/mK, and the coating had a porosity of only approximately 20%.

In addition, however, an erosion coating was applied onto the SPS coating by way of the APS process.

The overall coating thickness of the above triple-layer system was approximately 340 μm, which was the same as the APS coating that was produced for comparison purposes.

FIG. 2 shows the reflection curve, given in %, over the wavelength for a conventional APS coating and two double layers according to the invention made from APS+SPS coatings, and these differ from each other in terms of the different coating thickness of the SPS coating. It is apparent that, because of the additionally applied SPS coating, the reflection over the entire wavelength range of 0.3 to 2.5 μm that was analyzed increased by at least 2.5% with the SPS coating which is 60 μm thick, and by at least 5% with the SPS coating which is 150 μm thick.

FIG. 3 compares a conventional APS coating and a triple-layer coating system embodiment according to the invention. Again, the coating system according to the invention exhibits a considerable improvement in terms of reflection over the analyzed wavelength range. The improvement notably occurs at wavelengths above 0.5 μm, with an increase in reflection of no less 5% being achieved.

Due to increased radiation dispersion within the SPS coating, the reflectivity of the entire coating system increases. In particular back scattering is considerably higher with SPS coatings than with pure APS coatings. This also has an advantageous effect in the triple-layer system, wherein the top coating is an APS coating.

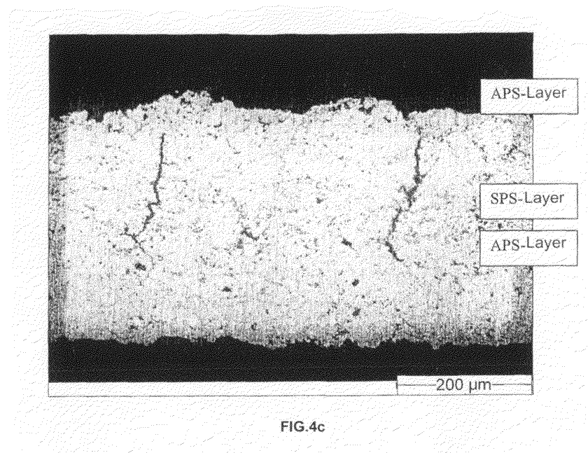

FIGS. 4a to 4c show images of the coating systems according to the invention. The microstructures in the tranverse micro-section of the two double layers are illustrated in FIGS. 4a and 4b. The coating thicknesses of the SPS layer are 60 and 150 μm, respectively, and those of the APS coatings are 270 and 200 μm, respectively. The SPS coating is interspersed with considerably finer pores, and cracks are apparent, which run through the coating, in particular vertically. Inside the APS coating, the pores are considerably coarser.

The microstructure in the transverse micro-section of the triple-layer system is shown in FIG. 4c. The SPS coating is characterized by high porosity, and particularly finer pores, as well as by an intensive crack network. In particular, vertical cracks are apparent. The coating thicknesses are 30 μm for the erosion coating, 170 μm for the SPS coating, and approximately 160 μm for the bottom APS coating.

The increased reflectivity of the coating, particularly in the visible (VIS) and the near infrared (NIR) wavelength range, advantageously causes a lower thermal load on the substrate material because, due to the higher reflectivity, a smaller proportion of thermal radiation penetrates the ceramic thermal barrier coating, thereby also resulting in less heating of the substrate (component).

1. A method for producing a coating system on a component comprising the steps of depositing at least one coating on the component by way of atmospheric plasma spraying (APS) and at least one further coating by way of suspension plasma spraying (SPS).

2. The method according to claim 1, wherein a further APS coating is deposited.

3. A method according to claim 1, wherein first an APS coating and then an SPS coating are applied onto the component.

4. A method according to claim 1, wherein first an APS coating, then an SPS coating, and then a further APS coating are applied onto the component.

5. A method according to claim 1, wherein at least one coating is applied as a graded coating.

6. A method according to claim 1, wherein an oxide ceramic is used as the material for the coating.

7. The method according to claim 1, wherein partially or fully stabilized zirconium oxide, aluminum oxide, an aluminate, a pyrochlore, or a perovskite is used as the material for the coating.

8. A method according to claim 6, wherein identical materials are used for at least one APS and one SPS coating.

9. A coating system on a component, comprising a first porous layer and a second porous layer disposed thereon, wherein the porosity of the second layer is greater than that of the first layer, and wherein the reflectivity is greater than that of the first layer.

10. The coating system according to claim 9, wherein the reflectivity in the visible (VIS) and in the near infrared (NIR) wavelength range is greater than that of the first layer.
